(19) United States
(12) Patent Application Publication
(10) Pub. No.: US 2008/0217433 A1
(43) Pub. Date: Sep. 11, 2008

(54) Street treatment method & apparatus

(76) Inventor: Ranger Kidwell-Ross, Bow, WA (US)

Correspondence Address: RANGER KIDWELL-ROSS, 2778 BARREL SPRINGS ROAD, BOW, WA, 98232, US

(21) Appl. No.: 12/009,547

(22) Filed: Jan. 18, 2008

Related U.S. Application Data
(60) Provisional application No. 60/886,442, filed on Jan. 24, 2007.

(51) Int. Cl. B05B 17/00

(52) U.S. Cl. 239/289

(57) ABSTRACT

The invention provides a street treatment system for bio-remediation and breakdown of oils and/or toxic compounds, as well as treatment of organic pests such as weeds, bugs and other naturally occurring organic material that are resident on man-made surfaces such as pavement, curb lines or other such surfaces. The invention uses a street sweeper that uses a mounted sprayer, tubing, a pump, a tank and controls located in the cab of the street sweeper to operate the apparatus. The tank holds the bio-remediation fluid or pesticide/weed killer that is then applied to the pavement, curb line, etc.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to surface conditioning and treatment vehicles such as street sweepers and particularly relates to treatment of surfaces with bio-remediation fluid or pesticides and/or weed killer chemicals. It is a material delivery system for the control and removal of unwanted, undesirable bio-hazardous substances or organic growths on surfaces utilizing existing equipment such as a street sweeper.

2. Background of the Invention

In the past, treatment systems have included an individual user equipped with a backpack-type spray tank that holds the bio-remediation fluid or the pesticide/weed killer, that is then applied to the pavement, curb line, etc. while the user is walking around in the environment exposed to various hazardous events. Street cleaners have been around for many years. They clean surfaces, but they do not spray, clean or remove the oil, bio-hazardous material, weeds, or other organic material. In order to obtain this objective, a street treatment system is needed that keeps the user safe while spraying, cleaning and/or removing of the oil, bio-hazardous material, weeds, or other organic material. This system achieves these objectives.

### BACKGROUND OF THE INVENTION

### Objects and Advantages

The objects and advantages of the street treatment method and apparatus are:
1. The operator is protected from injury and contamination from bio-remediation fluid, pesticides and/or weed killer chemicals.
2. The bio-hazardous materials on the surface can be removed, counter acted or neutralized in a safe, non-hazardous manner through the use of bio-remediation fluid.
3. Surfaces can be remediated while operating a street sweeper in a normal manner without resorting to extra work for the operator.
4. Existing equipment may be used, with minor alterations, for the addition of the street treatment method and apparatus.

### SUMMARY

The invention is a street treatment system that has been adapted for use on a street sweeper. The street treatment system uses a fluid that can be a bio-remediation fluid such as an oil compound breakdown type of fluid, a weed killer, or a pesticide. The system affords safety to the operator and allows the removal of the unwanted material in a safe manner, using existing equipment.

### DRAWINGS

### Figures

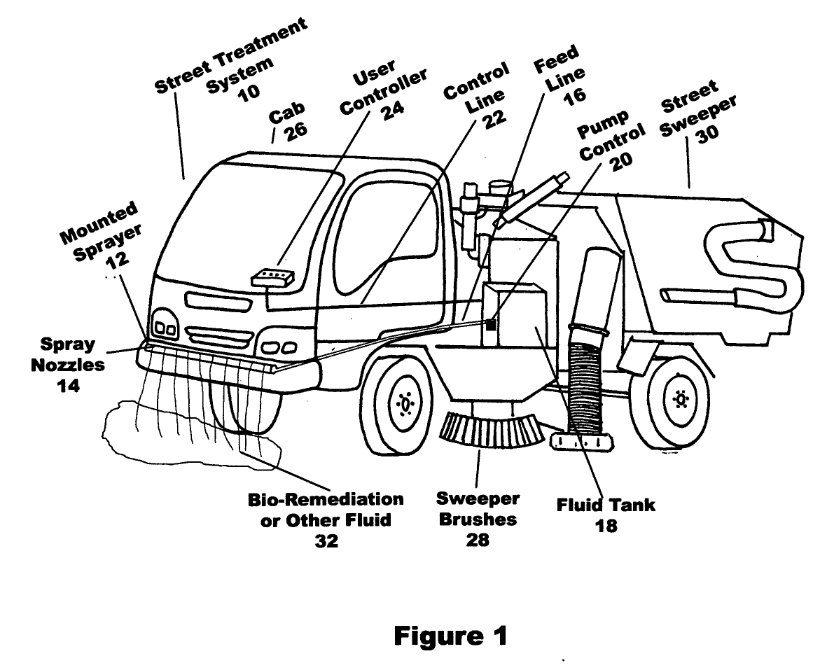

FIG. 1. Shows the side view of the Street Treatment Method & Apparatus.

### REFERENCE NUMERALS

10. Street treatment system.
12. Mounted sprayer.
14. Spray nozzles.
16. Feed line.
18. Fluid tank.
20. Pump control.
22. Control line.
24. Controller.
26. Cab.
28. Sweeper brushes portion.
30. Street sweeper.
32. Fluid.

### EMBODIMENTS AND FUNCTIONS

The general nature of this particular concept is to provide a street treatment system. The street treatment system can include bio-remediation of oils and/or toxic compounds on the pavement, as well as treatment of organic pests such as weeds, bugs, and the like, that property owners have to deal with on a continual basis for maintenance of their street, parking lot, street front as it borders the pavement and curb line.

In the past, treatment systems have included an individual user equipped with a backpack-type spray tank that holds the bio-remediation fluid or the pesticide/weed killer, that is then applied to the pavement, curb line, etc. while the user is walking around in the environment exposed to various hazardous events . . . .

Referring to FIG. 1, a street treatment system 10 has been adapted for use on a street sweeper 30. The street treatment system 10 has four main components: a mounted sprayer 12 that in this particular embodiment is a transversely aligned cylindrical tube that accepts the fluid 32 from a feed line 16 running from a fluid tank 18. The fluid can be a bio-remediation fluid such as an oil compound breakdown type of fluid, a weed killer, or a pesticide. Other types of fluids are also easily envisioned for treatment as desired by the property owners of the streetscape.

A pump control 20 that in this particular embodiment is resident within the fluid tank 18 is controlled by a controller 24 that sends signals from the cab 26 along the control line 22 to the pump, enabling the operator of the street sweeper to adjust the pressure in the feed line 16 on and off, thus controlling the distribution of the fluid 32 through the spray nozzles 14.

The fluid tank 18 is currently mounted on the side of the street sweeper 30. Other arrangements and configurations are envisioned. The sprayer 12 can be mounted on the side; it may have an articulating motor that it is arranged to provide for a range of angular spray distances depending on hard-to-reach areas. Furthermore, the sprayer may be mounted below the cab, or on the side of the body of the street sweeper, to access treatment for curb-line type of applications. For example, applying a weed killer through the use of the system to treat weeds or other organic pests during sweeping of the gutter. This offers the contracting street sweeper additional options for services rendered to property owners. The fluid 32 can be a host of different man-made, or naturally occurring, bio-enzyme type oil remediation and breakdown compounds applicable to the pavement. During an additional step of the process, the street sweeper's brushes 28 work the bio-remediation into the pavement for a strong application.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to falling within the scope of the invention as defined by the claims that follow.

1. A device for holding and distributing microorganisms in combination with a street sweeper or similar device.

2. The control mechanism for operating the spraying of microorganisms at various pavement locations relative to the street sweeper or similar device.

3. A mechanism for engaging and disengaging the distribution of microorganisms to dissolve and organically react with oil-based or other undesirable material upon street or similar surfaces and curbing.

4. A method of achieving the cleaning of oil slicks and other undesirable compounds on pavement by and through the use of a street sweeper or similar device.
